(19) United States
(12) Patent Application Publication
(10) Pub. No.: US 2012/0237266 A1
(43) Pub. Date: Sep. 20, 2012

(54) Developing Apparatus and Image Forming Apparatus

(75) Inventors: Kazuma MIYAZAWA, Shiojiri-shi (JP); Tsutomu SASAKI, Matsumoto-shi (JP); Kazuhiro NISHIYAMA, Shiojiri-shi (JP); Naoyuki OKUMURA, Shimosuwa-machi (JP)

(73) Assignee: SEIKO EPSON CORPORATION, Tokyo (JP)

(21) Appl. No.: 13/397,267

(22) Filed: Feb. 15, 2012

(30) Foreign Application Priority Data
Mar. 17, 2011 (JP) 2011-059074

(51) Int. Cl. G03G 15/10

(52) U.S. Cl. 399/238

(57) ABSTRACT

A driving force produced by a first driving motor is transmitted to a developing roller and an intermediate application roller by a first drive transmission unit, and the developing roller and the intermediate application roller are rotated as a result. The developing roller and the intermediate application roller thus take the first driving motor as a drive source, and receive the driving force from the first driving motor via the same first drive transmission unit. As a result, the phases of the fluctuation in a rotational component of the first driving motor and the cyclic fluctuation of gear interlocking match, which reduces a rotational velocity difference between the developing roller and the intermediate application roller.

### BACKGROUND

1. Technical Field

The present invention relates to developing apparatuses that develop images using a liquid developer containing toner and a carrier liquid, and to image forming apparatuses provided with such developing apparatuses.

2. Related Art

At present, liquid developer-type image forming apparatuses, in which a toner image is formed by forming an electrostatic latent image upon a charged photosensitive member and the electrostatic latent image is developed using a liquid developer in which toner is dispersed throughout a carrier liquid, are in practical use. For example, with a developing apparatus that is employed in the image forming apparatus according to JP-A-2009-204973 (in particular, FIG. 2), a developer receptacle is provided with a supply unit that contains a liquid developer to be borne on a developing roller that is rotationally driven by a developing roller motor. The liquid developer is supplied from the supply unit in the developer receptacle to the developing roller by an anilox roller, which has a non-planar surface formed from, for example, spiral-shaped grooves, being rotationally driven by an anilox roller motor that is different from the aforementioned roller and coming into contact with the developing roller.

Although the stated developing apparatus employs what is known as a two-roller structure, in which the anilox roller supplies the liquid developer to the developing roller by making contact with the developing roller while rotating, what is known as a three-roller structure, in which an intermediate application roller is interposed between the two stated rollers in order to protect the developing roller, has also been proposed. Here, adding another motor for rotationally driving the intermediate application roller will not only lead to an increase in the cost of the apparatus, but will make it necessary to take into consideration the effects of heat generated by the additional motor; this will in turn make it necessary to take measures with respect to the developing apparatus and, by extension, to the image forming apparatus that is provided with the stated developing apparatus. Accordingly, what is needed is a technique for a three-roller structure that favorably supplies liquid developer from a receptacle to a developing roller by driving the rollers with high precision using only two motors.

### SUMMARY

It is an advantage of some aspects of the invention to provide a technique for favorably supplying a liquid developer to a developer bearing roller by driving, with high precision, a first supply roller, a second supply roller, and the developer bearing roller using two drive sources, in what is known as a three-roller structure developing apparatus and an image forming apparatus provided with such a developing apparatus, in which a liquid developer held in a developer receptacle serving as a reservoir unit is supplied to the developer bearing roller via the first supply roller and the second supply roller.

A developing apparatus according to a first aspect of the invention includes: a reservoir unit that holds a liquid developer containing toner and a carrier liquid; a first supply roller that bears the liquid developer held in the reservoir unit by rotating; a second supply roller to which the liquid developer is supplied from the first supply roller by rotating while making contact with the first supply roller; a developer bearing roller that bears the liquid developer supplied from the second supply roller by rotating while making contact with the second supply roller; a first drive source that drives the developer bearing roller and the second supply roller; and a second drive source that drives the first supply roller.

Meanwhile, an image forming apparatus according to a second aspect of the invention includes: a latent image bearing member on which a latent image is formed; a developing unit that develops the latent image formed on the latent image bearing member, the developing unit having a reservoir unit that holds a liquid developer containing toner and a carrier liquid, a first supply roller that bears the liquid developer held in the reservoir unit by rotating, a second supply roller to which the liquid developer is supplied from the first supply roller by rotating while making contact with the first supply roller, and a developer bearing roller that bears the liquid developer supplied from the second supply roller by rotating while making contact with the second supply roller; a first drive source that drives the developer bearing roller and the second supply roller; and a second drive source that drives the first supply roller.

According to the inventions the developing apparatus and the image forming apparatus) configured in this manner, the liquid developer held in the reservoir unit is supplied to the second supply roller by the first supply roller, and is further supplied to the developer bearing roller from the second supply roller. Of these, the developer bearing roller and the second supply roller are driven by the first drive source, and thus error between the rotational velocities of the developer bearing roller and the second supply roller is reduced. Meanwhile, the first supply roller is driven by the second drive source, which is different than the first drive source, and thus the first supply roller can be driven at a different rotational velocity than the rotational velocity of the second supply roller; this makes it possible to adjust the amount of the liquid developer supplied to the developer bearing roller. In other words, the amount of the liquid developer supplied to the second supply roller from the first supply roller is adjusted based on the rotational velocity difference between the first supply roller and the second supply roller, which makes it possible to adjust the amount of the liquid developer supplied to the developer bearing roller from the second supply roller; this in turn makes it possible to apply the liquid developer to the developer bearing roller in a favorable manner.

Here, it is preferable that the image forming apparatus further include a drive transmission unit that causes the developer bearing roller to rotate, and causes the second supply roller to rotate in the same direction as the rotational direction of the developer bearing roller and at the same rotational velocity as the developer bearing roller or at a higher rotational velocity than the developer bearing roller, by transmitting a driving force produced by the first drive source to the developer bearing roller and the second supply roller.

In addition, it is preferable that the drive transmission unit have a first drive transmission member disposed coaxially with a rotational shaft of the first drive source, and a second drive transmission member disposed coaxially with a rotational shaft of the developer bearing roller and connected to the first drive transmission member.

In addition, it is preferable that the configuration be such that under a rotational force produced by the second drive source, the first supply roller rotates in the opposite direction as the rotational direction of the second supply roller and rotates at a rotational velocity that is lower than the rotational velocity of the second supply roller.

It is preferable that the image forming apparatus further include an adjustment unit that adjusts the rotational velocity of the first supply roller.

It is preferable that the image forming apparatus further include an agitation member that is disposed in the reservoir unit and that agitates the liquid developer held in the reservoir unit by rotating under the driving force produced by the first drive source.

Furthermore, it is preferable that the image forming apparatus further include: a cleaning unit that cleans the developer bearing roller and collects the liquid developer; a collection unit that holds the liquid developer collected by the cleaning unit; and a transport member that is disposed in the collection unit and that transports the liquid developer collected in the collection unit by rotating under the driving force produced by the second drive source.

### BRIEF DESCRIPTION OF THE DRAWINGS

The invention will be described with reference to the accompanying drawings, wherein like numbers reference like elements.

FIG. 1 is a diagram illustrating an image forming apparatus provided with a first embodiment of a developing apparatus according to the invention.

FIG. 2 is a diagram illustrating a developing unit according to the first embodiment of the developing apparatus according to the invention.

FIG. 3 is a diagram illustrating the configuration of a first driving motor and a first drive transmission unit.

FIG. 4 is a diagram illustrating the configuration of a second driving motor and a second drive transmission unit.

FIGS. 5A and 5B are diagrams illustrating differences in rotational velocities between a developing roller and an intermediate application roller.

FIG. 6 is a graph illustrating a relationship between a phase difference and a fluctuation rate of a rotational velocity.

FIGS. 7A and 7B are diagrams analyzing a force received by an intermediate application roller from a developing roller and an anilox roller.

FIGS. 8A and 8B are graphs illustrating fluctuation rates of a rotational velocity of an intermediate application roller.

FIGS. 9A and 9B are schematic diagrams illustrating the states of liquid surface level within a reservoir unit resulting from differences in drive sources.

FIG. 10 is a diagram illustrating a second embodiment of a developing apparatus according to the invention.

FIG. 11 is a partial enlarged perspective view of the apparatus shown in FIG. 10.

### DESCRIPTION OF EXEMPLARY EMBODIMENTS

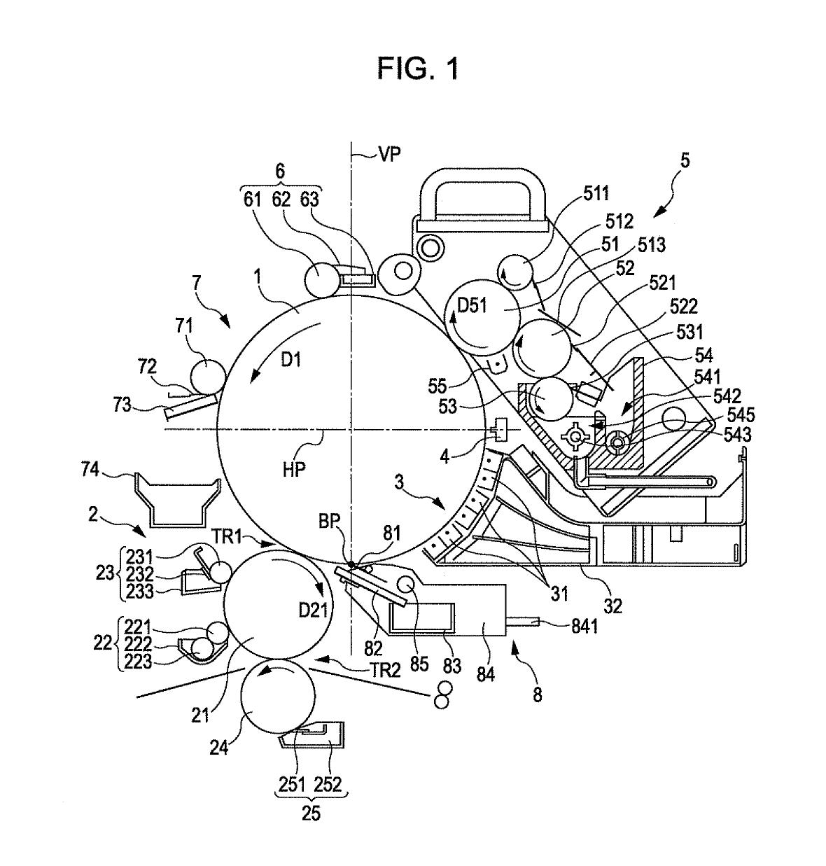

FIG. 1 is a diagram illustrating an image forming apparatus provided with a first embodiment of a developing apparatus according to the invention. This image forming apparatus has what is known as a “lower transfer structure”, in which an image borne upon a photosensitive drum 1 is transferred to a blanket roller 21 in a primary transfer unit 2 and the image transferred to the blanket roller 21 is further transferred onto transfer paper, the transfer process occurring below an imaginary horizontal plane HP that passes through the rotational center of the photosensitive drum 1. Note that, as will be described later, the image forming apparatus in FIG. 1 forms a single-color toner image and transfers that image onto the transfer paper, but it is also possible to configure a color printing system in which a plurality (for example, four) of such apparatuses are provided in an array. Of course, the apparatus shown in FIG. 1 also functions independently as a monochromatic image forming apparatus.

In this image forming apparatus, the photosensitive drum 1 has, on its surface, a photosensitive layer configured of a photosensitive material such as an amorphous silicon photosensor. The photosensitive drum 1 is disposed so that its rotational axis is parallel or approximately parallel to the main scanning direction (the direction vertical relative to the drawing plane of FIG. 1), and is rotationally driven at a predetermined velocity in the direction of the arrow D1 in FIG. 1.

A charging unit 3 that charges the surface of the photosensitive drum 1 to a predetermined potential, an exposure unit 4 that forms an electrostatic latent image by exposing the surface of the photosensitive drum 1 based on an image signal, a developing unit 5 that develops the electrostatic latent image using a liquid developer and forms a toner image, a first squeezing unit 6, a second squeezing unit 7, the blanket roller 21 of the primary transfer unit 2, and a photosensitive member cleaning unit 8 that cleans the surface of the photosensitive drum 1 following the primary transfer are disposed, in that order along the rotational direction D1 of the photosensitive drum 1 (in FIG. 1, the counterclockwise direction).

The charging unit 3 includes six chargers 31 and a charger airflow duct 32, and is disposed to the right of an imaginary vertical plane VP that passes through the rotational center of the photosensitive drum 1 and below the imaginary horizontal plane HP that passes through the rotational center of the photosensitive drum 1 shown in FIG. 1. The chargers 31 do not make contact with the surface of the photosensitive drum 1, and the six chargers 31 are disposed following the rotational direction D1 of the photosensitive drum 1. For example, a known corona charging unit used in the past can be employed as the charger 31. In the case where a scorotron charging unit is employed as the corona charging unit, a wire current flows through a charge wire of the scorotron charging unit, and a direct-current (DC) grid-charging bias is applied to the grid. In this manner, the photosensitive drum 1 is charged by the corona discharge emitted by the chargers 31, and the potential of the surface of the photosensitive drum 1 is set to an approximately uniform potential. Meanwhile, the charger airflow duct 32 includes an outside air introduction channel (not shown) that conducts outside air toward the chargers 31 and an exhaust channel (not shown) that exhausts atmosphere produced by the discharge of the chargers 31, and manages the atmosphere by ventilating the atmosphere in which the charging process is carried out.

The exposure unit 4 is disposed to the right of the imaginary vertical plane VP and above the imaginary horizontal plane HP shown in FIG. 1, and forms an electrostatic latent image corresponding to an image signal supplied from an external device by exposing the photosensitive drum 1 with a light beam in accordance with the image signal. Although a line head in which light-emitting elements are arranged in the main scanning direction (the vertical direction of the drawing plane in FIG. 1) is used as the exposure unit 4 in this embodiment, it is also possible for a light beam from a semiconductor laser to scan in the main scanning direction using a polygon mirror and so on. Although the exposure unit 4 is disposed above the imaginary horizontal plane HP in this embodiment, it should be noted that the position in which the exposure unit 4 is disposed is not limited thereto, and the exposure unit 4 may be disposed above or below the imaginary horizontal plane HP.

The developing unit 5 serving as a first embodiment of the developing apparatus according to the invention applies the liquid developer to the electrostatic latent image formed in this manner, and the electrostatic latent image is developed by the toner as a result. In this embodiment, a liquid developer in which colored resin particles serving as toner have been dispersed at a weight ratio of approximately 25% within a carrier liquid that takes an insulative liquid as its primary component is used, and the toner is given an electrical charge so as to be capable of electrophoresis within an electrical field. Note that the concentration of this developer is not limited to the stated 25%, and may be from 10 to 30%. Furthermore, Isopar (an Exxon brand), silicone oil, normal paraffin oil, or the like is used as the carrier liquid. It is preferable for the electric resistance to be greater than or equal to 10¹⁰ Ω·cm, and further preferable for the electric resistance to be greater than or equal to 10¹² Ω·cm. This is because in the case where the resistance is low, there is the possibility that excess current will flow through the toner during the electrophoresis, making it impossible to maintain the electrical field required for movement. Furthermore, although the viscosity of the liquid developer prepared in this manner varies depending on the resin of which the toner is configured, the dispersant/charge control agent, and so on, a liquid developer having a viscosity of 50 to 500 mPa·s can be used, and in this embodiment, a liquid developer having a viscosity of 400 mPa·s is used. Note that the configuration and operations of the developing unit 5 will be described in detail later.

The first squeezing unit 6 is disposed downstream, in the rotational direction D1 of the photosensitive drum 1, from a developing position at which the electrostatic latent image is developed by the stated liquid developer, and the second squeezing unit 7 is furthermore disposed downstream from the first squeezing unit 6. In this embodiment, a squeeze roller 61 of the first squeezing unit 6 and a squeeze roller 71 of the second squeezing unit 7 are both disposed to the left of the imaginary vertical plane VP and above the imaginary horizontal plane HP as shown in FIG. 1.

The squeeze roller 61 is provided, in the first squeezing unit 6, in a state biased toward the photosensitive drum 1 by a spring (not shown). The squeeze roller 61 is rotationally driven by a motor (not shown) while coming into contact with the surface of the photosensitive drum 1 at a first squeeze position, and removes excess developer from the toner image. Meanwhile, in this embodiment, the configuration is such that a first squeeze bias generation unit (not shown) is electrically connected to the squeeze roller 61 in order to increase the squeezing efficiency, and a first squeeze bias is applied to the squeeze roller 61 at an appropriate timing. In addition, a cleaning blade 62 makes contact with the surface of the squeeze roller 61, and wipes off liquid developer that has adhered to the surface of the roller. The liquid developer that has been wiped off in this manner is collected in a collection member 63.

Furthermore, in the second squeezing unit 7, the squeeze roller 71 rotates while making contact with the surface of the photosensitive drum 1 at a second squeeze position that is downstream from the first squeeze position in the rotational direction D1 of the photosensitive drum 1, and removes excess carrier liquid, fog toner, and so on from the toner image. Meanwhile, as with the first squeezing unit 6, in this embodiment, the configuration is such that a second squeeze bias generation unit (not shown) is electrically connected to the squeeze roller 71 in order to increase the squeezing efficiency, and a second squeeze bias is applied to the squeeze roller 71 at an appropriate timing. In addition, a cleaning blade 72 makes contact with the surface of the squeeze roller 71, and wipes off liquid developer that has adhered to the surface of the roller. The liquid developer that has been wiped off in this manner is guided away from the photosensitive drum 1 by a guide member 73, and is collected in a collection member 74 that is disposed below the guide member 73.

Although the two squeezing units 6 and 7 are provided in this embodiment, it should be noted that the number and arrangement of squeezing units is not intended to be limited thereto; for example, a single squeezing unit may be provided.

A toner image corresponding to an image signal supplied from an external apparatus is formed on the photosensitive drum 1 that has passed the first and second squeezing units 6 and 7, and the toner image is transferred to the blanket roller 21 at a primary transfer position TR1. The transfer unit 2 that includes this blanket roller 21 is disposed to the left of the imaginary vertical plane VP and below the imaginary horizontal plane HP as shown in FIG. 1. The transfer unit 2 includes the blanket roller 21, a carrier application mechanism 22 that applies the carrier liquid to the blanket roller 21, a cleaning unit 23 for the blanket roller 21, a secondary transfer roller 24, and a cleaning unit 25 for the secondary transfer roller 24.

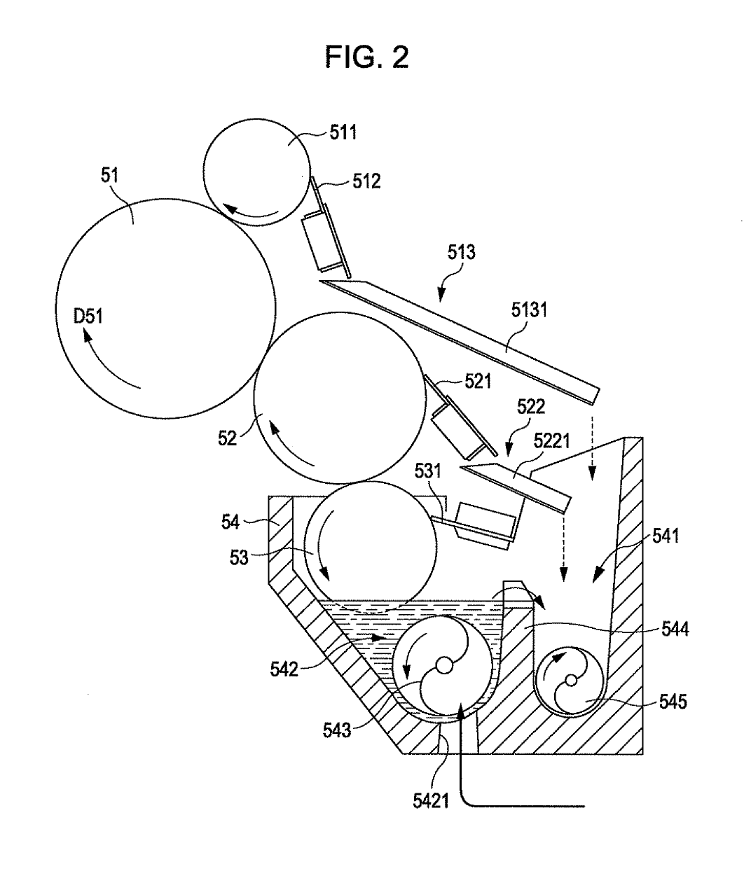

The surface of the blanket roller 21 forms a primary transfer nip with the surface of the photosensitive drum 1 by making contact with the surface of the photosensitive drum 1 upstream from the photosensitive drum 1 in the rotational direction D1 and with respect to a position (called a “lowermost position” hereinafter) BP where the surface of the photosensitive drum 1 intersects with the imaginary vertical plane VP below the photosensitive drum 1 in the vertical direction. The position at which this primary transfer nip is formed corresponds to the primary transfer position TR1. Furthermore, a motor (not shown) is connected to the blanket roller 21, and the blanket roller 21 is rotationally driven in the clockwise direction D21 shown in FIGS. 1 and 2, thus rotating concurrently with the photosensitive drum 1. The toner image borne on the photosensitive drum 1 thus undergoes a primary transfer onto the blanket roller 21 at the primary transfer position TR1.

Meanwhile, a secondary transfer nip is formed between the blanket roller 21 and the secondary transfer roller 24 downstream from the primary transfer position TR1 in the rotational direction D21 of the blanket roller 21, by the secondary transfer roller 24 making contact with the blanket roller 21 and rotating therewith. The position at which this secondary transfer nip is formed corresponds to a secondary transfer position TR2. Accordingly, when the transfer paper is supplied to the secondary transfer position TR2 by a transport unit (not shown) and passes through the secondary transfer nip, the toner image that was transferred onto the blanket roller 21 undergoes a secondary transfer onto the transfer paper. In this manner, an image that uses the aforementioned liquid developer is printed onto the transfer paper.

In addition, the carrier application mechanism 22 is disposed downstream from the secondary transfer position TR2 in the rotational direction D21 of the blanket roller 21, and applies the carrier liquid to the surface of the blanket roller 21 following the secondary transfer. In order to carry out the process for applying the carrier liquid, the carrier application mechanism 22 includes: a carrier application roller 221 that rotates along with the blanket roller 21; a carrier reservoir member 222 that holds the carrier liquid; and a carrier lifting roller 223 that lifts the carrier liquid from the carrier reservoir member 222 and supplies the carrier liquid to the carrier application roller 221.

The cleaning unit 23 is disposed downstream from the carrier application mechanism 22 and upstream from the primary transfer position TR1 in the rotational direction D21 of the blanket roller 21, and cleans the surface of the blanket roller 21 immediately before the primary transfer. In order to carry out this cleaning process, the cleaning unit 23 includes: a cleaning roller 231 that rotates counter to the blanket roller 21; a cleaning blade 232 that cleans the cleaning roller 231 by making contact with the cleaning roller 231; and a collection member 233 that collects toner, carrier liquid, and so on that have been wiped off by the cleaning blade 232.

The cleaning unit 25 is disposed upstream from the secondary transfer position TR2 in the rotational direction of the secondary transfer roller 24, and cleans the surface of the secondary transfer roller 24 immediately before the secondary transfer. In order to carry out this cleaning process, the cleaning unit 25 includes: a cleaning blade 251 that cleans the secondary transfer roller 24 by making contact with the secondary transfer roller 24; and a collection member 252 that collects toner, carrier liquid, and so on that have been wiped off by the cleaning blade 251.

The photosensitive member cleaning unit 8 is disposed downstream from the primary transfer position TR1 and upstream from the charging position in the rotational direction D1 of the photosensitive drum 1. The photosensitive member cleaning unit 8 includes: a cleaning blade 81; a developer receiving member 82 that receives liquid developer that drips down from the lowermost position BP of the photosensitive drum 1; a collection member 83 that collects the developer received by the developer receiving member 82; and a support member 84 that supports the cleaning blade 81, the developer receiving member 82, and the collection member 83 in an integrated manner. The support member 84 is capable of rotating central to a rotation shaft 85.

Meanwhile, the support member 84 is connected to a spring member (not shown) that biases the support member 84 in the counterclockwise direction shown in FIG. 1; the spring member acts in the direction that pushes the cleaning blade 81 away from the photosensitive drum 1. An engagement portion 841 is provided so as to protrude from the end of the support member 84 on the opposite side as the photosensitive drum (the right side in FIG. 1), and when a mobile portion (not shown) pushes down on the engagement portion 841 with a force greater than the stated biasing force, the support member 84 is rotated in the clockwise direction in FIG. 1; as a result, the cleaning blade 81 moves toward the photosensitive drum and the tip of the cleaning blade 81 makes contact with the photosensitive drum 1 at the lowermost position BP. Through this, liquid developer that remains on the photosensitive drum 1 is removed through cleaning. Note that the liquid developer wiped off by the cleaning blade 81 in this manner is received by the developer receiving member 82 disposed below the lowermost position BP of the photosensitive drum 1, and then flows along a sloped surface of the developer receiving member 82 and into the collection member 83, where that liquid developer is then held.

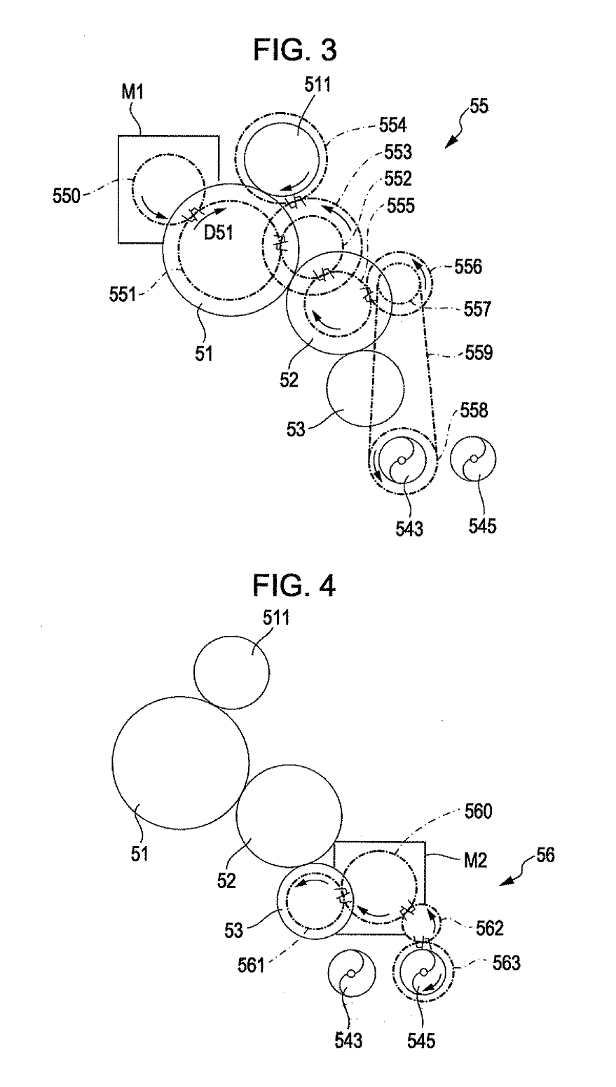

Next, the developing unit 5 will be described. Here, the configuration of the developing unit 5 will first be described with reference to FIGS. 1 and 2, after which a configuration for driving the respective elements of the developing unit 5 will be described with reference to FIGS. 3 and 4.

FIG. 2 is a diagram illustrating the developing unit according to the first embodiment of the developing apparatus according to the invention. As shown in FIGS. 1 and 2, the developing unit 5 has what is known as a three-roller configuration, and includes: a developing roller (developer bearing roller) 51; an intermediate application roller (second supply roller) 52; and an anilox roller (first supply roller) 53. The rollers 51 through 53 are disposed so that their rotational axes are parallel to the rotational axis of the photosensitive drum 1, and are axially supported on each end of each roller so as to be capable of rotation by a pair of side plates (not shown). To be more specific, the respective rollers 51 through 53 are configured as described hereinafter.

The developing roller 51 is a cylindrical member, in which an elastic layer such as polyurethane rubber, silicone rubber, NPR, or the like is provided around a metal inner core configured of steel or the like; furthermore, PFA tubing, a resin coating, or the like is provided as the surface layer of the developing roller, which is the outermost layer. This developing roller 51 is connected to a first driving motor M1 (see FIG. 3) via a first drive transmission unit 55 (again, see FIG. 3). When the first driving motor M1 is operated in accordance with a control instruction from a control unit (not shown) that controls the apparatus as a whole, the developing roller 51 is rotationally driven in the clockwise direction D51 shown in FIGS. 1 and 2 by the driving force from the first driving motor M1; the developing roller 51 rotates, while making contact with the surface of the photosensitive drum 1, so that the surface of the developing roller 51 moves in the same direction as the surface of the photosensitive drum 1 (this is referred to “concurrent rotation” hereinafter). In addition, the developing roller 51 is electrically connected to a developing bias generation unit (not shown), and the configuration is such that a developing bias is applied to the developing roller 51 at an appropriate timing.

Meanwhile, the intermediate application roller 52 and the anilox roller 53 are provided for supplying the liquid developer to the developing roller 51; the liquid developer is supplied to the developing roller 51 from the anilox roller 53 via the intermediate application roller 52. While the intermediate application roller 52 has, like the developing roller 51, an elastic layer provided around an inner metal core, the anilox roller 53 is a roller in whose surface is formed an indentation pattern, configured of engraved, extremely fine and uniform spiral grooves, in order to make it easy for the anilox roller 53 to bear the liquid developer. Of course, like the developing roller 51 and the intermediate application roller 52, a roller in which a rubber layer such as urethane or NBR is wrapped around a metal inner core, PFA tubing is provided around the metal inner core, or the like may be used as the anilox roller 53.

Of these rollers, the intermediate application roller 52 rotates in the clockwise direction shown in FIGS. 1 and 2 having received a driving force from the first driving motor M1 via the first drive transmission unit 55 (see FIG. 3), and the circumferential surface of the intermediate application roller 52 moves in the opposite rotational direction as the developing roller 51 while the surfaces of the intermediate application roller 52 and the developing roller 51 come into contact with each other (this will be called “counter rotation” hereinafter). Meanwhile, the anilox roller 53 is connected to a second driving motor M2 (see FIG. 4) via a second drive transmission unit 56 (again, see FIG. 4). When the second driving motor M2 is then operated in accordance with a control instruction from the control unit, the anilox roller 53 is rotated in the counterclockwise direction shown in FIGS. 1 and 2 as a result of the driving force from the second driving motor M2; the circumferential surface of the anilox roller 53 then moves in the same rotational direction as the intermediate application roller 52 while the surface of the anilox roller 53 makes contact with the surface of the intermediate application roller 52, thus rotating concurrently with the intermediate application roller 52. In this manner, in this embodiment, the liquid developer is supplied from a developer receptacle 54 to the developing roller 51 using the so-called three-roller configuration, and thus, by the liquid developer making a plurality of passes through nips, the liquid developer can be sufficiently kneaded, which in turn makes it possible to form a uniform film of the liquid developer on the developing roller 51.

In this embodiment, a cleaning unit is provided in order to clean the liquid developer from the developing roller 51. This cleaning unit includes a cleaning roller 511 and a roller cleaning blade 512, and carries out a cleaning process on the developing roller 51 by the cleaning roller 511 making contact with the developing roller 51 and the roller cleaning blade 512 making contact with the cleaning roller 511. To be more specific, the cleaning roller 511 rotates in the clockwise direction shown in FIGS. 1 and 2 having received a driving force from the first driving motor M1 (see FIG. 3) via the first drive transmission unit 55 (again, see FIG. 3), and rotates counter to the developing roller 51 while the surface of the cleaning roller 511 makes contact with the surface of the developing roller 51; this removes the liquid developer that does not contribute to the developing but has remained on the developing roller 51. Furthermore, by making contact with the surface of the cleaning roller 511, the roller cleaning blade 512 wipes off the stated liquid developer.

A sloped member 513 is disposed below the roller cleaning blade 512 and above the intermediate application roller 52 in the vertical direction. The end of the sloped member 513 on the side of the developing roller (the left side in FIG. 2) is higher in the vertical direction than the end of the sloped member 513 on the side opposite to the developing roller (the right side in FIG. 2), and the sloped member 513 slopes downward as it progresses away from the developing roller 51, extending to above a collection unit 541 of a developer receptacle 54. The sloped member 513 is anchored to a side plate so that the end on the side of the developing roller is positioned below the roller cleaning blade 512.

In addition, side fences (wall portions) 5131 are erected upward on the sloped member 513 on both sides of the width direction X thereof. The side fences 5131 extend toward the end of the sloped member 513 on the opposite side as the developing roller, and guide the liquid developer (waste liquid) to above the collection unit 541. The liquid developer that has been collected from this position drips down into the collection unit 541. Accordingly, the sloped member 513 receives all of the liquid developer (waste liquid) collected by the roller cleaning blade 512 and causes that liquid developer to flow into the collection unit 541 of the developer receptacle 54.

Meanwhile, a cleaning blade 521 makes contact with the intermediate application roller 52, and wipes off liquid developer that does not contribute to the developing but remains on the intermediate application roller 52 from the intermediate application roller 52.

A sloped member 522 is disposed below the cleaning blade 521. Like the sloped member 513, the end of the sloped member 522 on the side of the intermediate application roller (the left side in FIG. 2) is higher in the vertical direction than the end of the sloped member 522 on the side opposite to the intermediate application roller (the right side in FIG. 2), and the sloped member 522 slopes downward as it progresses away from the intermediate application roller 52, extending to above the collection unit 541 of the developer receptacle 54. The sloped member 522 is anchored to a side plate so that the end on the side of the intermediate application roller is positioned below the roller cleaning blade 521.

In addition, side fences (wall portions) 5221 are erected upward on the sloped member 522 on both sides of the width direction X thereof. The side fences 5221 extend toward the end of the sloped member 522 on the opposite side as the intermediate application roller, and guide the liquid developer (waste liquid) to above the collection unit 541. The liquid developer that has been collected from this position drips down into the collection unit 541. Accordingly, the sloped member 522 receives all of the liquid developer (waste liquid) collected by the cleaning blade 521 and causes that liquid developer to flow into the collection unit 541 of the developer receptacle 54.

Meanwhile, a regulation member 531 makes contact with the anilox roller 53. Although an elastic member configured of a metal or configured by covering a surface with an elastic material can be used as the regulation member 531, the regulation member 531 according to this embodiment is configured of a rubber portion composed of urethane rubber or the like that makes contact with the surface of the anilox roller 53 and a metal plate that supports the rubber portion. The regulation member 531 functions so as to adjust and regulate the film thickness, amount, and so on of the liquid developer borne and transported by the anilox roller 53, and in doing so, adjust the amount of liquid developer supplied to the developing roller 51. Meanwhile, the liquid developer wiped off by the regulation member 531 is returned to a reservoir unit 542 in the developer receptacle 54. Note that an agitation auger 543 is disposed in the reservoir unit 542, and as will be described later, the agitation auger 543 is rotated in the counterclockwise direction shown in FIGS. 1 and 2 having received a driving force from the first driving motor M1 (see FIG. 3) via the first drive transmission unit 55 (again, see FIG. 3), thus agitating the liquid developer within the reservoir unit 542.

The reservoir unit 542 of the developer receptacle 54 functions, as described above, so as to hold the liquid developer that is to be supplied to the developing roller 51 via the anilox roller 53 and the intermediate application roller 52, and as shown in FIG. 2, liquid developer whose concentration has been adjusted is replenished as appropriate through a replenishment port 5421 provided in a central area of the bottom surface of the reservoir unit 542. Within a reservoir unit 542, the liquid developer is agitated as a result of the rotation of the agitation auger 543, and is transported in the axial direction (the vertical direction of the drawing plane, in FIGS. 1 and 2) of the agitation auger 543. In this embodiment, the agitation auger 543 transports the liquid developer in different directions starting at the replenishment port 5421, and thus the liquid developer that has flowed in from the replenishment port 5421 is transported both toward and away from the viewer of FIG. 2.

A wall member 544 that divides the developer receptacle 54 into the collection unit 541 and the reservoir unit 542 extends in the axial direction (the vertical direction of the drawing plane, in FIGS. 1 and 2). Collection ports (not shown) configured by partially cutting out the upper end of the wall member 544 are provided on both ends in the axial direction X of the wall member 544, and the configuration is such that the liquid developer transported within a reservoir unit 542 by the agitation auger 543 overflows through the collection ports and flows into the collection unit 541. By employing such an overflow structure, the liquid surface level of the liquid developer can be kept constant within the reservoir unit 542, and the liquid developer can be supplied to the developing roller 51 in a uniform manner via the anilox roller 53 and the intermediate application roller 52.

The liquid developer that overflows from the reservoir unit 542 and the liquid developer that has been collected through the cleaning flow into the collection unit 541. A collection auger (collection screw) 545 is disposed within the collection unit 541, and as will be described later, the collection auger 545 is rotated in the clockwise direction shown in FIGS. 1 and 2 having received a driving force from the second driving motor M2 (see FIG. 4) via the second drive transmission unit 56 (again, see FIG. 4); the collected liquid developer is transported in one direction parallel to the direction of the rotation shaft of the developing roller 51 (the vertical direction of the drawing plane, in FIG. 2), and is caused to flow out from a transport hole (not shown) provided in a side surface of the collection unit 541.

Next, a configuration for rotating the respective elements of the developing unit 5 as described above will be described with reference to FIGS. 3 and 4. FIG. 3 is a diagram illustrating the configuration of the first driving motor and the first drive transmission unit, whereas FIG. 4 is a diagram illustrating the configuration of the second driving motor and the second drive transmission unit.

As shown in FIG. 3, the first driving motor M1 is, as described earlier, a drive source for driving the developing roller 51, the intermediate application roller 52, and the agitation auger 543; the rotational driving force produced by the first driving motor M1 is transmitted to the respective rotational shafts of the developing roller 51, the intermediate application roller 52, and the agitation auger 543 by the first drive transmission unit 55, which has a drivetrain configured as described hereinafter. In this manner, in this embodiment, the first driving motor M1 and the first drive transmission unit 55 respectively correspond to a “first drive source” and a “drive transmission unit” according to the invention.

Reference numeral 550 in FIG. 3 indicates an output shaft gear that is attached to the rotational shaft of the first driving motor M1, and a developing drive gear 551 interlocks with the output shaft gear 550. The developing drive gear 551 is attached to the rotational shaft of the developing roller 51, and the driving force produced by the first driving motor M1 is transmitted to the rotational shaft of the developing roller 51 via the output shaft gear 550 and the developing drive gear 551. Through this, the developing roller 51 is rotationally driven.

The developing drive gear 551 also interlocks with a first idle gear 552. A second idle gear 553 is attached coaxially with the first idle gear 552. Furthermore, a cleaning drive gear 554 interlocks with the second idle gear 553. The cleaning drive gear 554 is attached to the rotational shaft of the cleaning roller 511, and the driving force produced by the first driving motor M1 is transmitted to the rotational shaft of the cleaning roller 511 via the gears 550 through 554. Through this, the cleaning roller 511 is rotationally driven.

An intermediate application drive gear 555 that is attached to the rotational shaft of the intermediate application roller 52 also interlocks with the first idle gear 552, and the driving force produced by the first driving motor M1 is transmitted to the rotational shaft of the intermediate application roller 52 via the gears 550 through 552 and 555. Through this, the intermediate application roller 52 rotates counter to the developing roller 51. Note that in this embodiment, the configuration is such that the numbers of the developing drive gear teeth 551, the first idle gear teeth 552, and the intermediate application drive gear 555 teeth fulfill the following relationships:

(number of developing drive gear teeth 551)>(number of first idle gear teeth 552)

(number of first idle gear teeth 552)=(number of intermediate application drive gear teeth 555)

Accordingly, the intermediate application roller 52 is rotated at a higher rotational velocity than the developing roller 51.

The intermediate application drive gear 555 also interlocks with a third idle gear 556. A fourth idle gear 557 is attached coaxially with the third idle gear 556. Furthermore, an agitation drive gear 558 is attached to the rotational shaft of the agitation auger 543. The fourth idle gear 557 and the agitation drive gear 558 are connected by a belt 559. Accordingly, the driving force produced by the first driving motor M1 is transmitted to the rotational shaft of the agitation auger 543 via the gears 550 through 552, 555 through 558, and the belt 559. Through this, the agitation auger 543 rotates in the counterclockwise direction shown in FIG. 3.

Meanwhile, as shown in FIG. 4, the second driving motor M2 is, as described earlier, a drive source for driving the anilox roller 53 and the collection auger 545; the rotational driving force produced by the second driving motor M2 is transmitted to the respective rotational shafts of the anilox roller 53 and the collection auger 545 by the second drive transmission unit 56, which has a drivetrain configured as described hereinafter. In this manner, in this embodiment, the second driving motor M2 corresponds to a “second drive source” according to the invention.

Reference numeral 560 in FIG. 4 indicates an output shaft gear that is attached to the rotational shaft of the second driving motor M2, and an anilox drive gear 561 and a fifth idle gear 562 interlock with the output shaft gear 560. Of these, the anilox drive gear 561 is attached to the rotational shaft of the anilox roller 53, and the driving force produced by the second driving motor M2 is transmitted to the rotational shaft of the anilox roller 53 via the gears 560 and 561. Through this, the anilox roller 53 is rotationally driven.

Meanwhile, the output shaft gear 560 also interlocks with the fifth idle gear 562, and furthermore, a collection drive gear 563 interlocks with the fifth idle gear 562. The collection drive gear 563 is attached to the rotational shaft of the collection auger 545, and the driving force produced by the second driving motor M2 is transmitted to the rotational shaft of the collection auger 545 via the gears, 560, 562, and 563. Through this, the collection auger 545 is rotationally driven.

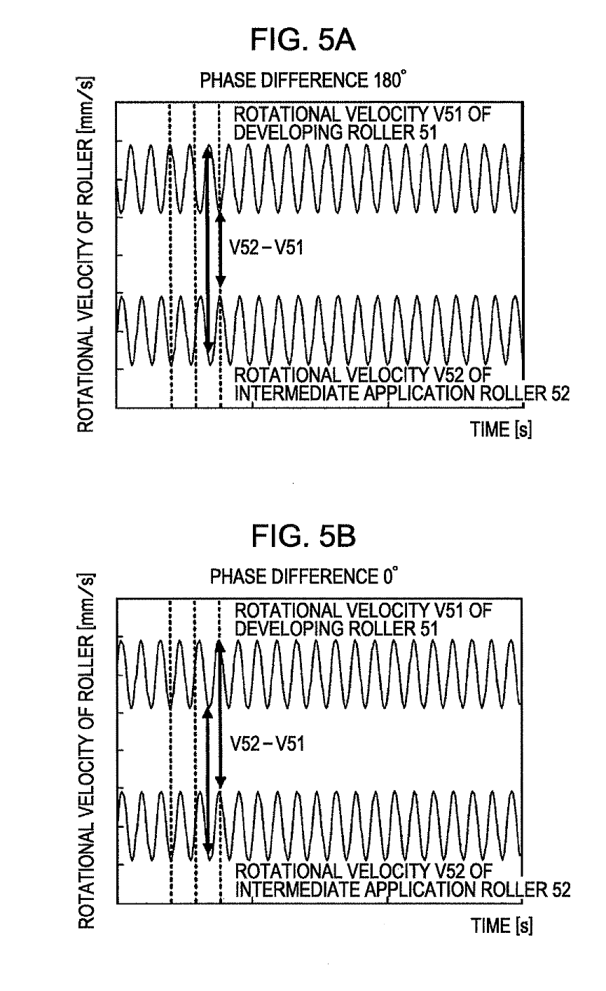

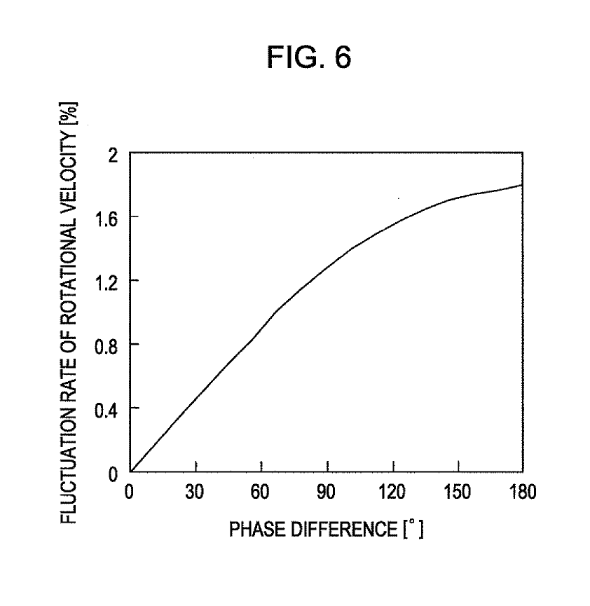

As described thus far, according to the first embodiment, the configuration is such that the driving force produced by the first driving motor M1 is transmitted to the developing roller 51 and the intermediate application roller 52 by the first drive transmission unit 55, thus rotating those rollers, and thus the following effects can be achieved. That is, a rotational component of the driving motor M1 fluctuates in a cyclic manner, and a cyclic fluctuation is also present in the interlocking of the gears that configure the first drive transmission unit 55. Accordingly, cyclic fluctuations such as those illustrated in FIGS. 5A and 5B are also present in a rotational velocity V51 of the developing roller 51 and a rotational velocity V52 of the intermediate application roller 52. For example, FIG. 5A indicates a rotational velocity difference when there is a phase difference of 180° between the rotational velocity V51 and the rotational velocity V52, whereas FIG. 5B indicates a rotational velocity difference when there is a phase difference of 0° between the rotational velocity V51 and the rotational velocity V52. In this manner, the rotational velocity difference (=V52−V51) fluctuates depending on the phase difference, and the graph shown in FIG. 6 is obtained by finding the fluctuation rate of the rotational velocity difference relative to the phase difference. As is clear from FIG. 6, there is a lower rotational velocity difference between the developing roller 51 and the intermediate application roller 52 as the phase difference drops, which makes it possible to stabilize the amount of the liquid developer supplied from the intermediate application roller 52 to the developing roller 51. With respect to this point, in the first embodiment, the developing roller 51 and the intermediate application roller 52 both take the first driving motor M1 as a drive source, and the driving force from the first driving motor M1 is transmitted via the same first drive transmission unit 55; accordingly, the phase of the fluctuation in the rotational component of the first driving motor M1 and the cyclic fluctuation of the gear interlocking match, and the rotational velocity difference between the developing roller 51 and the intermediate application roller 52 drops, which in turn makes it possible to stabilize the supply of the liquid developer to the developing roller 51.

Furthermore, in the stated first embodiment, the teeth numbers of the gears 551, 552, and 555 that configure the first drive transmission unit 55 are set so that the intermediate application roller 52 rotates at a higher rotational velocity than the developing roller 51, in the opposite direction as the developing roller 51. Accordingly, as described above, the liquid developer can be supplied to the developing roller 51 without stretching the liquid developer layer formed on the intermediate application roller 52, which makes it possible to supply a uniform, smooth layer of the liquid developer to the surface of the developing roller 51. Note that the configuration may be such that the intermediate application roller 52 rotates at the same rotational velocity as the rotational velocity of the developing roller 51, and the same effects can be achieved in such a case as well.

In addition, in the first embodiment, the second driving motor M2, which is separate from the drive source that drives the developing roller 51 and the intermediate application roller 52 (the first driving motor M1), is provided, and the rotational velocity of the anilox roller 53 is adjusted by controlling the rotational frequency of the second driving motor M2 in accordance with an instruction from the control unit. Accordingly, a rotational velocity difference can be caused between the intermediate application roller 52 and the anilox roller 53, which makes it possible to adjust the amount of liquid developer supplied, or in other words, the thickness of the liquid developer layer formed on the intermediate application roller 52, based on the rotational velocity difference. In this manner, in this embodiment, the control unit functions as an “adjustment unit” according to the invention.

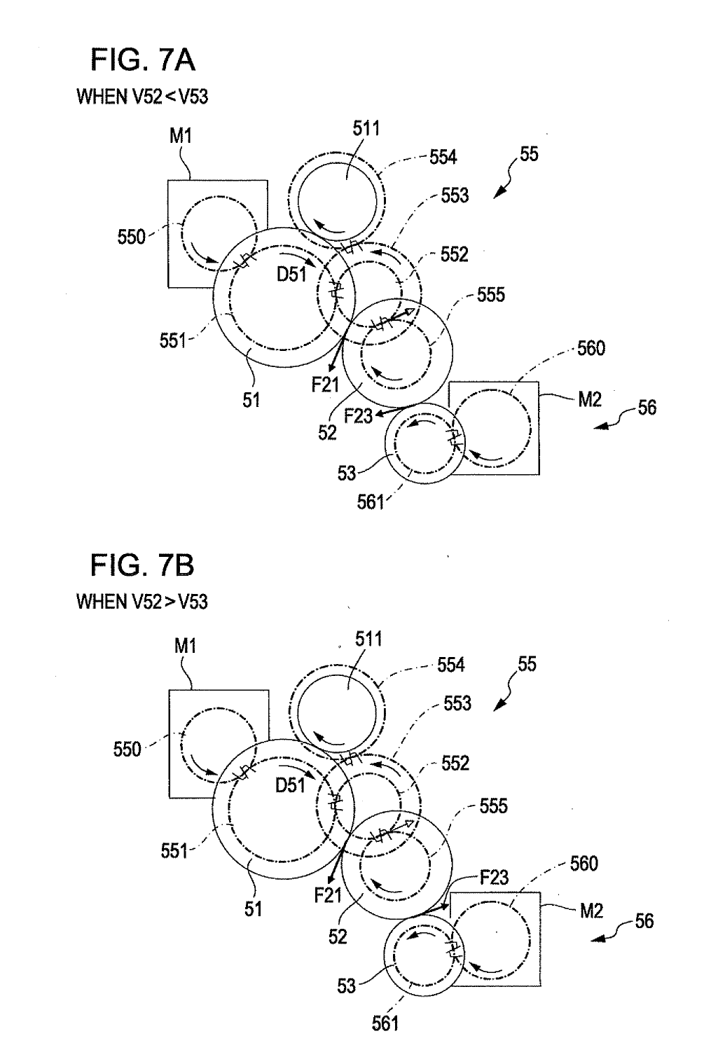

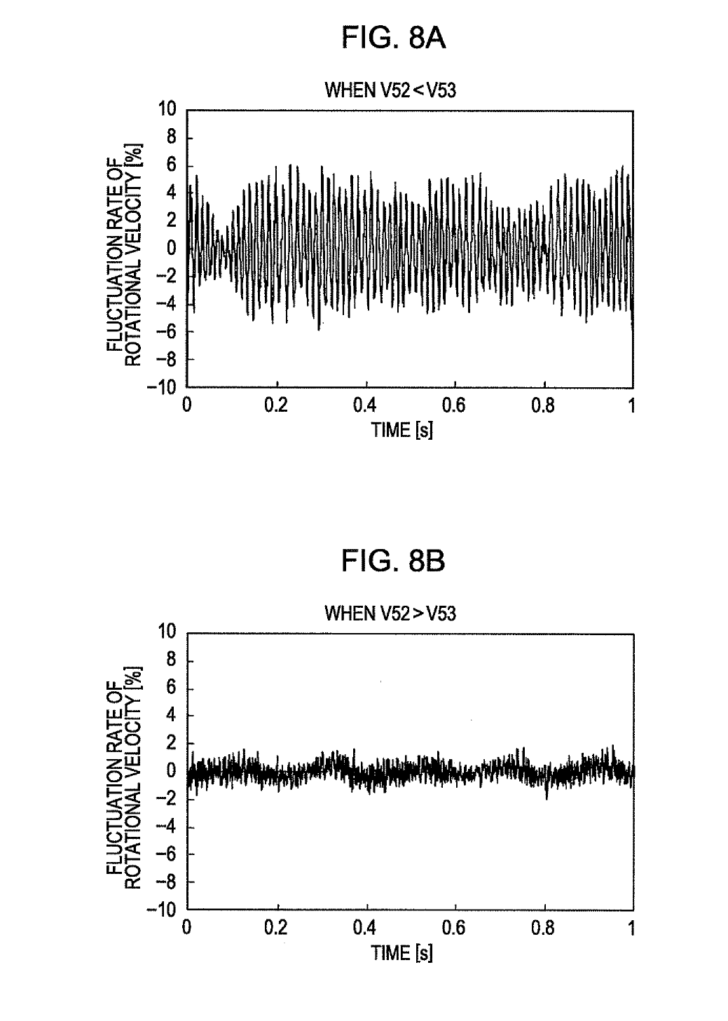

Furthermore, the rotational precision can be increased by the anilox roller 53 moving, based on an instruction from the control unit, in the same direction as the intermediate application roller 52 at a lower rotational velocity than the intermediate application roller 52, or in other words, by the anilox roller 53 rotating concurrently relative to the intermediate application roller 52. The reason for this will be described with reference to FIGS. 7A, 7B, 8A, and 8B.

FIGS. 7A and 7B are diagrams analyzing the force received by the intermediate application roller from the developing roller and the anilox roller; FIG. 7A illustrates a case where the rotational velocity of the anilox roller is higher than the rotational velocity of the intermediate application roller, whereas FIG. 7B illustrates a case where the rotational velocity of the anilox roller is lower than the rotational velocity of the intermediate application roller. Meanwhile, FIGS. 8A and 8B are graphs illustrating the fluctuation rate of the rotational velocity of the intermediate application roller; FIG. 8A illustrates a case where the rotational velocity of the anilox roller is higher than the rotational velocity of the intermediate application roller, whereas FIG. 8B illustrates a case where the rotational velocity of the anilox roller is lower than the rotational velocity of the intermediate application roller. With the developing unit 5 according to the first embodiment, the intermediate application roller 52 receives a tangential force (friction) F21 from the developing roller 51 and receives a tangential force (friction) F23 from the anilox roller 53; the orientations of the tangential forces F21 and F23 depend on the relationship between the magnitudes of the rotational velocity V52 of the intermediate application roller 52 and a rotational velocity V53 of the anilox roller 53. In other words, in the case where the rotational velocity V53 of the anilox roller 53 is higher than the rotational velocity V52 of the intermediate application roller 52, the orientations of the tangential forces F21 and F23 will, as shown in FIG. 7A, be in directions opposite from each other; as a result, the direction in which the gears interlock becomes uncertain, and thus the interlock becomes unstable. As a result, a rotational fluctuation equivalent to the amount of backlash in the gears is produced, resulting in an increase in the fluctuation of the rotational velocity V52 of the intermediate application roller 52 (see FIG. 8A).

As opposed to this, in the case where the rotational velocity V53 of the anilox roller 53 is lower than the rotational velocity V52 of the intermediate application roller 52, the orientations of the tangential forces F21 and F23 will, as shown in FIG. 7B, be in the same direction, resulting in the gears interlocking in a stable manner in the direction in which the intermediate application roller 52 is rotated, which in turn makes it possible to pre-load the gears. As a result, as shown in FIG. 8B, the fluctuation in the rotational velocity V52 of the intermediate application roller 52 is low, and thus the intermediate application roller 52 can be rotated with high precision.

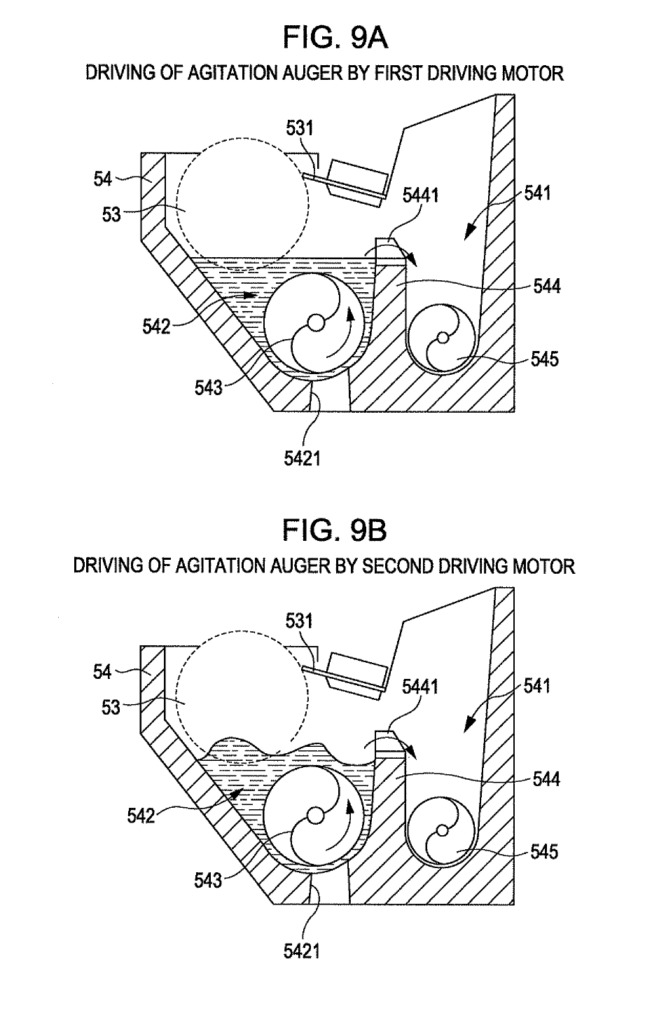

Furthermore, in the first embodiment, the driving force produced by the first driving motor M1 is transmitted to the rotation shaft of the agitation auger 543 and rotates the agitation auger 543, and thus the following effects can be achieved. With the stated developing unit 5, the two driving motors M1 and M2 are provided, and thus one of the driving motors M1 and M2 can be used as the drive source for driving the agitation auger 543. Here, in the case where the first driving motor M1 is used as the drive source for the agitation auger 543, as in the first embodiment, the agitation auger 543 is driven by the same drive train as the developing roller 51, and thus the rotational frequency of the agitation auger 543 is constant. Accordingly, as shown in FIG. 9A, it is possible to stabilize the liquid surface of the liquid developer held in the reservoir unit 542 of the developer receptacle 54, which in turn makes it possible to stabilize the amount of the liquid developer that is lifted from the reservoir unit 542 by the anilox roller 53. As a result, the amount of liquid developer applied to the developing roller 51 is constant, which makes it possible to develop images with superior image quality, without producing unevenness in the darkness of the images.

On the other hand, if the second driving motor M2, which serves as the drive source of the anilox roller 53, is used as a drive source of the agitation auger 543, the liquid surface of the liquid developer held in a reservoir unit 542 of the developer receptacle 54 will become unstably agitated, as shown in FIG. 95. This is because the rotational frequency of the anilox roller 53 can change at any time in accordance with the required application amount, and thus the rotational frequency of the agitation auger 543 will also change along therewith. Accordingly, in the reservoir unit 542, the level of the liquid surface of the liquid developer fluctuates greatly, which can lead to variations in the amount of liquid developer that is lifted by the anilox roller 53. As a result, the amount of liquid developer that is applied to the developing roller 51 fluctuates, which can lead to the occurrence of unevenness in the darkness of the image.

In this manner, according to the first embodiment configured so that the driving force produced by the first driving motor M1, which serves as a drive source of the developing roller 51, is applied to and rotates the agitation auger 543 via the first drive transmission unit 55, it is possible to stabilize the amount of liquid developer that is applied and achieve an improvement in the image quality.

Furthermore, according to the stated first embodiment, the second driving motor M2 is used as the drive source of the collection auger 545, and thus the following effects can be achieved. The collection auger 545 is disposed in the collection unit 541 of the developer receptacle 54, and functions so as to transport the liquid developer collected in the collection unit 541 (collected liquid) and prevent the collected liquid from overflowing from the collection unit 541. The amount of the liquid developer collected in the collection unit 541 increases/decreases in proportion to the amount of liquid developer that is lifted by the anilox roller 53. Accordingly, if the collection auger 545 is constantly rotated at a rotational frequency that corresponds to the maximum amount of liquid developer lifted by the anilox roller 53, it is possible to prevent the collected liquid from overflowing from the collection unit 541. However, maintaining a high rotational frequency makes it more likely that seals (not shown) at the ends of the shaft will wear and degrade. Accordingly, in this embodiment, because the amount of liquid developer lifted by the anilox roller 53 is proportional to the rotational frequency of the anilox roller 53, the collection auger 545 is connected to the second driving motor M2, which serves as the drive source of the anilox roller 53, via the second drive transmission unit 56, as shown in FIG. 4. In other words, the configuration is such that the rotational frequency of the collection auger 545 increases/decreases in proportion with the rotational frequency of the anilox roller 53. Through this, when the rotational frequency of the anilox roller 53 is increased and a greater amount of liquid developer is used, it is possible to prevent the collected liquid from overflowing from the collection unit 541 by increasing the rotational frequency of the collection auger 545; on the other hand, if the rotational frequency of the anilox roller 53 is reduced and a smaller amount of liquid developer is used, it is possible to prevent the seals from degrading through the reduction in the rotational frequency of the collection auger 545. In this manner, controlling the rotational frequency of the collection auger 545 in accordance with the conditions of usage of the liquid developer makes it possible to both prevent the collected liquid from overflowing and prevent the seals from degrading.

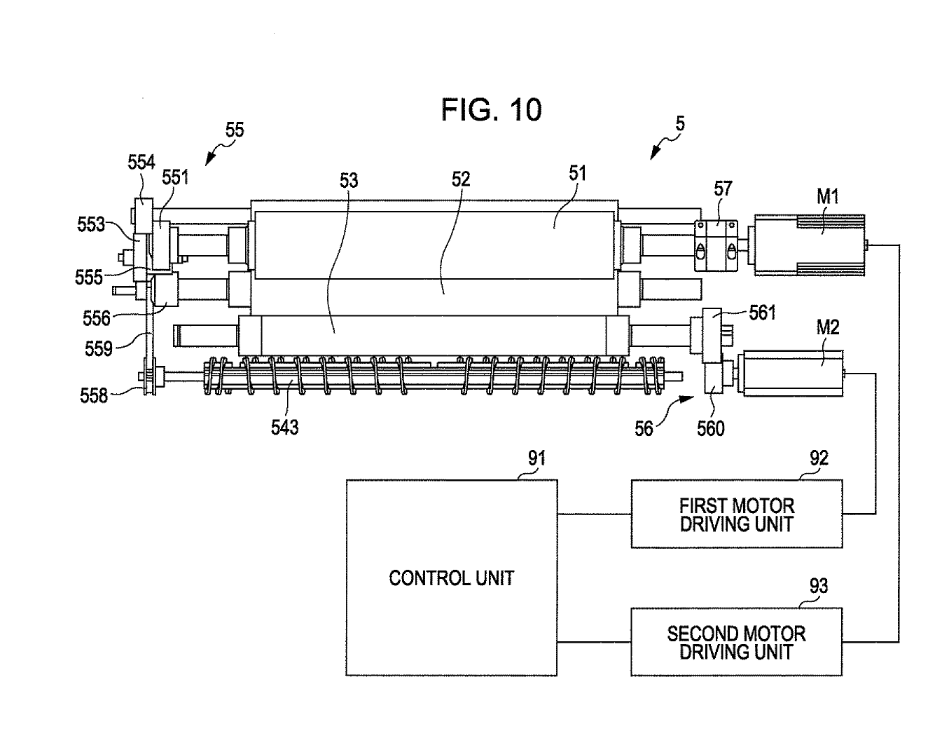

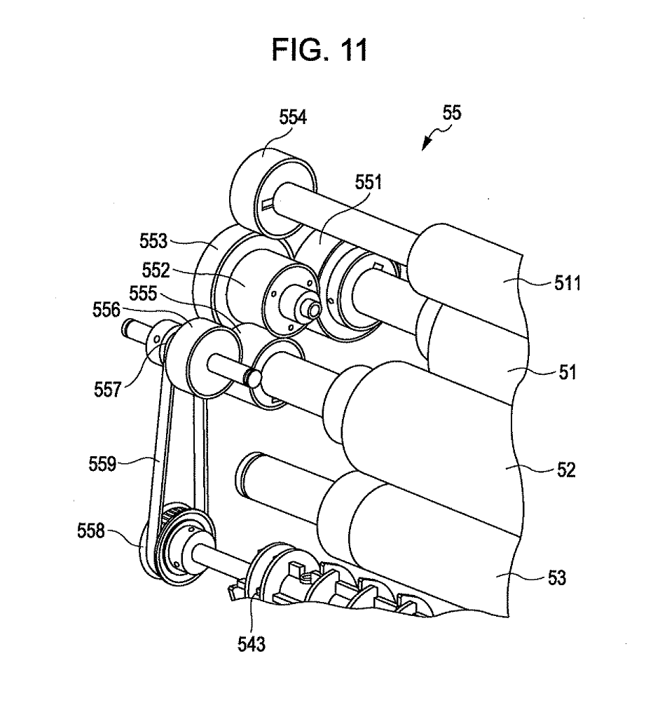

Note that the invention is not limited to the aforementioned embodiment, and various modifications are possible in addition to the content described above without departing from the spirit of the invention. For example, the configurations of the first drive transmission unit 55 and the second drive transmission unit 56 are not limited to the configurations employed in the stated first embodiment; for example, as shown in FIG. 10, the rotational shaft of the first driving motor M1 may be directly linked to one end of the rotational shaft of the developing roller 51 via a coupling (connection member) 57 (a second embodiment). In the second embodiment, the coupling 57 includes a first drive transmission member (not shown) which is disposed coaxially with the rotational shaft of the first driving motor M1, and a second drive transmission member (not shown) which is disposed coaxially with the rotational shaft of the developing roller 51 and connected to the first drive transmission member. Accordingly, the rotational precision can be increased as compared to the first embodiment, in which the first driving motor M1 and the developing roller 51 are connected via the gears 550 and 551, making the second embodiment a favorable embodiment. In addition, in the second embodiment that employs a direct-drive system as described here, the configuration may, as shown in FIGS. 10 and 11, be such that the gear 551 is attached to the other end of the rotational shaft of the developing roller 51, the gears 552 through 558 and the belt 559 are provided as in the first embodiment, and the intermediate application roller 52 and the agitation auger 543 rotate along with the rotation of the developing roller 51. Note that reference numeral 91 in FIG. 10 indicates a control unit that controls the image forming apparatus as a whole, whereas reference numerals 92 and 93 indicate a first motor driving unit and a second motor driving unit that drive the driving motors M1 and M2, respectively, based on control instructions from the control unit 91; here, the control unit 91 functions as the “adjustment unit” according to the invention.

Meanwhile, a geared motor may be used as the first driving motor M1 in order to reduce the number of gears of which the first drive transmission unit 55 is configured.

Furthermore, the aforementioned embodiments describe a case in which the invention is applied in an image forming apparatus having what is known as a lower transfer structure. However, the invention is not limited to being applied in such a structure; for example, the invention can also be applied in an image forming apparatus having what is known as an upper transfer structure, in which an image borne on the photosensitive drum 1 is transferred above the imaginary horizontal plane HP that passes through the rotational center of the photosensitive drum 1.

The entire disclosure of Japanese Patent Application No. 2011-059074, filed Mar. 17, 2011 is expressly incorporated by reference herein.

What is claimed is:

1. A developing apparatus comprising:
a reservoir unit that holds a liquid developer containing toner and a carrier liquid;
a first supply roller that bears the liquid developer held in the reservoir unit by rotating;
a second supply roller to which the liquid developer is supplied from the first supply roller by rotating while making contact with the first supply roller;
a developer bearing roller that bears the liquid developer supplied from the second supply roller by rotating while making contact with the second supply roller;
a first drive source that drives the developer bearing roller and the second supply roller; and
a second drive source that drives the first supply roller.

2. An image forming apparatus comprising:
a latent image bearing member on which a latent image is formed;
a developing unit that develops the latent image formed on the latent image bearing member, the developing unit including a reservoir unit that holds a liquid developer containing toner and a carrier liquid, a first supply roller that bears the liquid developer held in the reservoir unit by rotating, a second supply roller to which the liquid developer is supplied from the first supply roller by rotating while making contact with the first supply roller, and a developer bearing roller that bears the liquid developer supplied from the second supply roller by rotating while making contact with the second supply roller;
a first drive source that drives the developer bearing roller and the second supply roller; and
a second drive source that drives the first supply roller.

3. The image forming apparatus according to claim 2, further comprising a drive transmission unit that causes the developer bearing roller to rotate, and causes the second supply roller to rotate in the same direction as the rotational direction of the developer bearing roller and at the same rotational velocity as the developer bearing roller or at a higher rotational velocity than the developer bearing roller, by transmitting a driving force produced by the first drive source to the developer bearing roller and the second supply roller.

4. The image forming apparatus according to claim 2, wherein the drive transmission unit includes a first drive transmission member disposed coaxially with a rotational shaft of the first drive source, and a second drive transmission member disposed coaxially with a rotational shaft of the developer bearing roller and connected to the first drive transmission member.

5. The image forming apparatus according to claim 2, wherein under a rotational force produced by the second drive source, the first supply roller rotates in the opposite direction as the rotational direction of the second supply roller and rotates at a rotational velocity that is lower than the rotational velocity of the second supply roller.

6. The image forming apparatus according to claim 2, further comprising an adjustment unit that adjusts the rotational velocity of the first supply roller.

7. The image forming apparatus according to claim 2, further comprising an agitation member that is disposed in the reservoir unit and that agitates the liquid developer held in the reservoir unit by rotating under the driving force produced by the first drive source.

8. The image forming apparatus according to claim 2, further comprising:
a cleaning unit that cleans the developer bearing roller and collects the liquid developer;
a collection unit that holds the liquid developer collected by the cleaning unit; and
a transport member that is disposed in the collection unit and that transports the liquid developer collected in the collection unit by rotating under the driving force produced by the second drive source.
